(19) United States
(12) Patent Application Publication
(10) Pub. No.: US 2025/0224654 A1
(43) Pub. Date: Jul. 10, 2025

(54) ACCESSORY, IMAGE PICKUP APPARATUS, AND CONTROL METHOD

(71) Applicant: CANON KABUSHIKI KAISHA, Tokyo (JP)

(72) Inventors: TAKUMI TAKEHARA, Kanagawa (JP); HIDEYA TAKANASHI, Kanagawa (JP)

(21) Appl. No.: 18/952,989

(22) Filed: Nov. 19, 2024

(30) Foreign Application Priority Data
Jan. 10, 2024 (JP) 2024-001585

(51) Int. Cl. G03B 17/14

(52) U.S. Cl. CPC G03B 17/14

(57) ABSTRACT

An accessory attachable and detachable between an interchangeable lens and an image pickup apparatus includes a communication unit communicable with the interchangeable lens and the image pickup apparatus, a protective member configured to suppress an external element entering the image pickup apparatus through a mount portion of the image pickup apparatus, and a processor configured to drive the protective member so as to suppress the external element upon receiving information regarding power off from the image pickup apparatus via the communication unit, control a first aperture unit via the communication unit upon receiving information regarding driving of the first aperture unit in the interchangeable lens from the image pickup apparatus via the communication unit, and control the first aperture unit using different methods before and after the processor receives the information regarding the power off.

### BACKGROUND

### Technical Field

The present disclosure relates to an accessory, an image pickup apparatus, and a control method.

### Description of Related Art

An image pickup apparatus configured to introduce a light beam incident through an interchangeable lens to an image sensor in a power-off state has conventionally been known. However, if this image pickup apparatus in the power-off state is erroneously pointed toward the sun, the image sensor may get damaged by strong light. In addition, in a case where the interchangeable lens is removed from the image pickup apparatus, dust may enter the image pickup apparatus through an opening in a mount portion and adhere to the image sensor.

Japanese Patent Application Laid-Open No. 2014-21281 discloses a configuration that protects an image sensor by closing an aperture stop in the interchangeable lens in a case where an image pickup apparatus is powered off.

The configuration disclosed in Japanese Patent Application Laid-Open No. 2014-21281 is effective in a case where an interchangeable lens that can maintain the aperture stop closed is attached. However, it is not effective for an interchangeable lens that has no aperture stop or an interchangeable lens that may break down if the power supply is cut off while the aperture in the aperture stop is narrowed. In addition, with the interchangeable lens that can maintain the aperture stop closed, the image sensor may be prevented from getting damaged, but the aperture stop in the interchangeable lens may get damaged instead.

### SUMMARY

An accessory according to one aspect of the disclosure is attachable and detachable between an interchangeable lens and an image pickup apparatus. The accessory includes a communication unit communicable with the interchangeable lens and the image pickup apparatus, a protective member configured to suppress an external element entering the image pickup apparatus through a mount portion of the image pickup apparatus, and a processor configured to drive the protective member so as to suppress the external element upon receiving information regarding power off from the image pickup apparatus via the communication unit, control a first aperture unit via the communication unit upon receiving information regarding driving of the first aperture unit in the interchangeable lens from the image pickup apparatus via the communication unit, and control the first aperture unit using different methods before and after the processor receives the information regarding the power off. A control method corresponding to the above accessory also constitutes another aspect of the disclosure.

An accessory according to another aspect is attachable and detachable between an interchangeable lens and an image pickup apparatus. The accessory includes a communication unit communicable with the interchangeable lens and the image pickup apparatus, a protective member configured to suppress an external element entering the image pickup apparatus through a mount portion of the image pickup apparatus, and a processor configured to drive the protective member so as to suppress the external element upon receiving a signal regarding a change in a state of the interchangeable lens via the communication unit. A control method corresponding to the above accessory also constitutes another aspect of the disclosure.

An image pickup apparatus according to another aspect of the disclosure is attachable to and detachable from an accessory that is attachable to and detachable from an interchangeable lens. The image pickup apparatus includes an image sensor, a first protective member configured to protect the image sensor, the accessory including a second protective member configured to suppress external element entering the image pickup apparatus through a mount portion of the image pickup apparatus, a communication unit communicable with the accessory, and a processor configured to transmit information regarding power off to the accessory via the communication unit, and not to drive the first protective member in a case where the accessory suppresses the external element using the second protective member or the processor receives a signal indicating that the accessory drives the second protective member, from the accessory via the communication unit. A control method corresponding to the above image pickup apparatus also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a block diagram of an imaging system according to each embodiment.

FIG. 2 explains each communication unit of the camera body, intermediate accessory, and interchangeable lens according to each embodiment.

FIGS. 3A, 3B, and 3C explain example protocols for communication carried out between the camera body, intermediate accessory, and interchangeable lens in each embodiment.

FIGS. 4A and 4B are external views of the intermediate accessory according to each embodiment.

FIG. 5A explains operation in a live-view image display state in a first embodiment.

FIG. 5B explains operation during power off according to the first embodiment.

FIG. 5C explains operation when the lens is removed in the first embodiment.

FIG. 6 explains an operation during power off according to a second embodiment.

FIG. 7 explains an operation during power off according to a third embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

### First Embodiment

### Configuration of Camera System

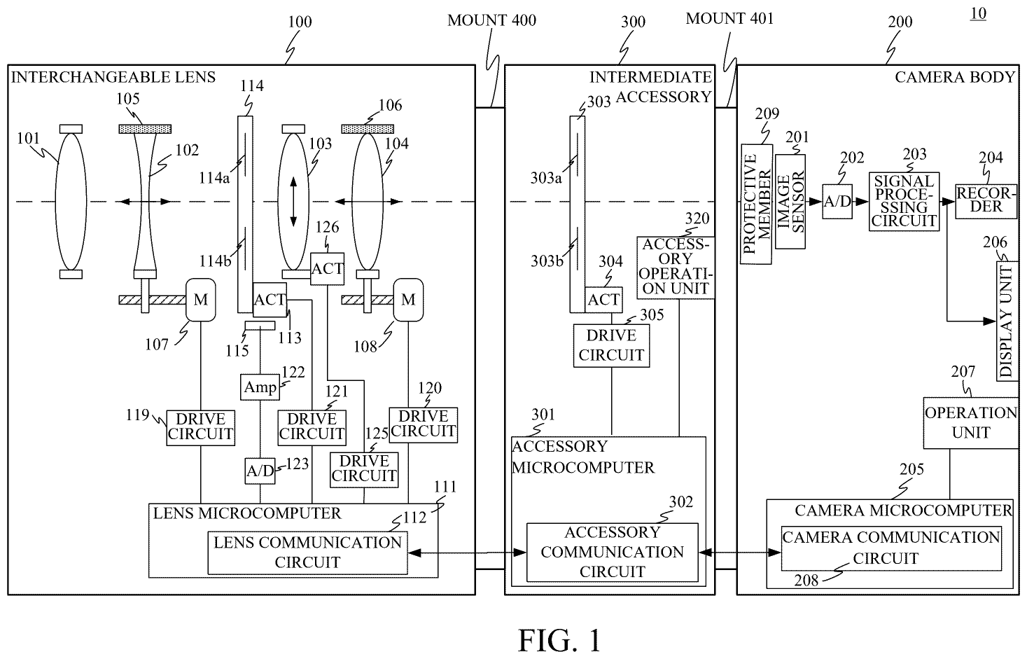

Referring now to FIG. 1, a description will be given of a camera system (imaging system) 10 according to a first embodiment of the present disclosure. FIG. 1 is a block diagram of the camera system 10. The camera system 10 includes an interchangeable lens 100, a camera body (image pickup apparatus) 200, and an intermediate accessory (accessory) 300 that is attachable and detachable between the camera body 200 and the interchangeable lens 100. The camera body 200 can be attached to the intermediate accessory 300, and can be used while both the interchangeable lens 100 and the intermediate accessory 300 are attached. In this embodiment, the intermediate accessory 300 includes one accessory, but it may include a plurality of accessories.

In this embodiment, communication is performed among the interchangeable lens 100, the camera body 200, and the intermediate accessory 300. The interchangeable lens 100, the camera body 200, and the intermediate accessory 300 transmit control commands and data (information) via their respective communication circuits (communication units) 112, 208, and 302.

A description will now be given of the specific configurations of the interchangeable lens 100, the camera body 200, and the intermediate accessory 300. The interchangeable lens 100 and the intermediate accessory 300 are mechanically and electrically connected via a mount 400. The mount 400 is illustrated in a schematic representation of a state in which a mount portion provided on the interchangeable lens 100 and a mount portion provided on the intermediate accessory 300 are joined together. The camera body 200 and the intermediate accessory 300 are mechanically and electrically connected via a mount 401. The mount 401 is illustrated in a schematic representation of a state in which a mount portion provided on the camera body 200 and a mount portion provided on the intermediate accessory 300 are joined together. A communication terminal is provided on the mount surface of the mount portion provided on each of the interchangeable lens 100, the camera body 200, and the intermediate accessory 300. In a case where each unit is connected via the mount, the corresponding communication terminals come into contact with each other, and the communications via the communication terminals are available.

The interchangeable lens 100 receives power from the camera body 200 via power terminals (not illustrated) provided on the mounts 400 and 401, and supplies power to various actuators described below and a lens microcomputer 111. The intermediate accessory 300 receives power from the camera body 200 via a power terminal (not illustrated) provided on the mount 401, and supplies power to an accessory microcomputer (control unit) 301.

A description of the configuration of the interchangeable lens 100 will now be given. The interchangeable lens 100 includes an imaging optical system. The imaging optical system includes, in order from the object side to the image side, a field lens 101, a zoom lens 102 configured to perform magnification variation, an aperture (stop) unit 114 configured to adjust a light amount, an image stabilizing lens 103, and a focus lens 104 configured to perform focusing.

The zoom lens 102 and the focus lens 104 are held by lens holding frames 105 and 106, respectively. Stepping motors 107 and 108 drive the lens holding frames 105 and 106 along the optical axis of the imaging optical system, which is indicated by a dashed line, in synchronization with a driving pulse. The image stabilizing lens 103 reduces image blur caused by camera shake or the like by moving in a direction that includes a component perpendicular to the optical axis of the imaging optical system.

The lens microcomputer 111 controls the operation of each component in the interchangeable lens 100. The lens microcomputer 111 receives control commands and transmission request commands transmitted from the camera body 200 or the intermediate accessory 300 via the lens communication circuit 112. The lens microcomputer 111 performs lens control corresponding to the control commands, and transmits lens data corresponding to the transmission request commands to the camera body 200 or the intermediate accessory 300 via the lens communication circuit 112. For example, the lens microcomputer 111 drives the stepping motors 107 and 108 by outputting drive signals to a zoom drive circuit 119 and a focus drive circuit 120 in response to commands relating to magnification variation and focusing among the control commands. Thereby, zoom processing configured to control a magnification varying operation by the zoom lens 102 and autofocus (AF) processing configured to control a focusing operation by the focus lens 104 are performed.

The aperture unit 114 is an aperture stop unit (first aperture unit) having aperture blades 114a and 114b. A Hall element 115 detects a state (position) of the aperture blades 114a and 114b. A detection result by the Hall element 115 is input to the lens microcomputer 111 via an amplifier circuit 122 and an A/D conversion circuit 123. The lens microcomputer 111 outputs a drive signal to an aperture drive circuit 121 based on the input signal from the A/D conversion circuit 123 to drive an aperture actuator 113. This allows the aperture unit 114 to adjust a light amount. The driving method of the aperture actuator 113 is not limited and any known method may be used.

The lens microcomputer 111 drives an image stabilizing actuator 126 such as a voice coil motor via an image stabilizing drive circuit 125 in response to a shake detected by a vibration sensor (not illustrated) such as a vibration gyroscope provided in the interchangeable lens 100. Thereby, image stabilizing processing to control a shift operation (image stabilizing operation) of the image stabilizing lens 103 is performed.

The plurality of lenses included in the interchangeable lens 100 are merely illustrative, and the interchangeable lens 100 may not include the zoom lens 102, the image stabilizing lens 103, and/or the focus lens 104. At least one of the zoom processing, AF processing, and image stabilizing processing may be performed by controlling a plurality of lenses.

A description of the configuration of the intermediate accessory 300 will now be given. The intermediate accessory 300 includes an accessory microcomputer 301, which controls various components included in the intermediate accessory. The accessory microcomputer 301 receives control commands and transmission request commands transmitted from the camera body 200 via an accessory communication circuit 302. The accessory microcomputer 301 performs accessory control in response to the control command, or transmits a control command to the interchangeable lens 100 via the accessory communication circuit 302. Then, as a result of performing accessory control, or based on information received from the interchangeable lens 100 via the accessory communication circuit 302, the accessory microcomputer 301 transmits to the camera body 200 a response corresponding to a transmission request command received from the camera body 200. The accessory microcomputer 301 does not necessarily transmit a transmission request command to the interchangeable lens 100 via the accessory communication circuit 302 only in response to a communication request from the camera body 200.

The intermediate accessory 300 further includes an accessory operation unit 320. The accessory operation unit 320 may be, for example, a switch, a button, a touch panel, or the like, and may include a plurality of operation members.

The intermediate accessory 300 further includes a protective member (second protective member) 303 that can shield incident light from the interchangeable lens 100 to the mount 401 and prevent the intrusion of dust, dirt, or water droplets such as raindrops. In other words, the protective member 303 suppresses external elements such as light (incident light), dust, and water droplets entering the camera body 200 through the mount portion of the camera body 200. The protective member 303 includes, for example, light shielding curtains 303a and 303b. The accessory microcomputer 301 outputs a drive signal to a drive circuit 305 configured to drive the protective member 303 and drives a protective member actuator 304. Thereby, the light shielding curtains 303a and 303b, and the opening and closed state of the protective member 303 are controlled. The protective member 303 is not limited to a configuration that includes a light shielding curtain, as long as it is a member that can shield incident light from the interchangeable lens 100 and prevent dust and water droplets from entering. The protective member 303 may include, for example, an aperture stop unit (second aperture unit) similar to the aperture unit 114 in the interchangeable lens 100. Whether the protective member 303 includes the light shielding curtains 303a and 303b or as an aperture stop unit, closing the protective member 303 can suppress external elements entering the camera body 200 through the mount portion of the camera body 200.

The intermediate accessory 300 may have, for example, a function of an extender configured to change a focal length, a wide converter configured to change a focal length, or a mount converter configured to change a flange back length.

A description of the configuration of the camera body 200 will now be given. The camera body 200 includes an image sensor 201 such as a CCD sensor or CMOS sensor, an A/D conversion circuit 202, a signal processing circuit 203, a recorder 204, a camera microcomputer 205, a display unit 206, and a protective member (first protective member) 209.

The image sensor 201 photoelectrically converts an object image formed by the imaging optical system in the interchangeable lens 100 and outputs an electrical signal (analog signal). The A/D conversion circuit 202 converts the analog signal from the image sensor 201 into a digital signal. The signal processing circuit 203 performs various image processing for the digital signal from the A/D conversion circuit 202 to generate a video signal (imaging signal).

The signal processing circuit 203 also generates from the video signal the contrast state of the object image, i.e., focus information illuminating the focus state of the imaging optical system and luminance information illuminating the exposure state. The signal processing circuit 203 outputs the video signal to the display unit 206, which displays the video signal as a live-view image that is used for the user to check a composition, focus state, and the like.

The camera microcomputer 205 controls the camera body 200 according to input from an operation unit 207 such as an imaging instruction switch and various setting switches. The camera microcomputer 205 also transmits control commands and transmission request commands to the interchangeable lens 100 or intermediate accessory 300 via a camera communication circuit 208, and receives lens data or accessory data from the interchangeable lens 100 or intermediate accessory 300. For example, the camera microcomputer 205 generates focus shift information at the signal processing circuit 203 based on information regarding optical characteristics, such as aperture diameter information of the aperture stop, received from the interchangeable lens 100 or the intermediate accessory 300 via the camera communication circuit 208. Then, based on the generated focus shift information, it generates focus information and transmits a control command regarding the focusing operation to the interchangeable lens 100. For example, the camera microcomputer 205 transmits a transmission request command to the interchangeable lens 100 to obtain lens data regarding the focusing operation, and receives lens data regarding to the focusing operation from the interchangeable lens 100. The protective member 209 protects the image sensor 201 by shielding a light beam incident on the mount 401 from the interchangeable lens 100 via the intermediate accessory 300 and by preventing the intrusion of dust and water droplets. The protective member 209 includes, for example, a focal plane shutter or a light shielding curtain.

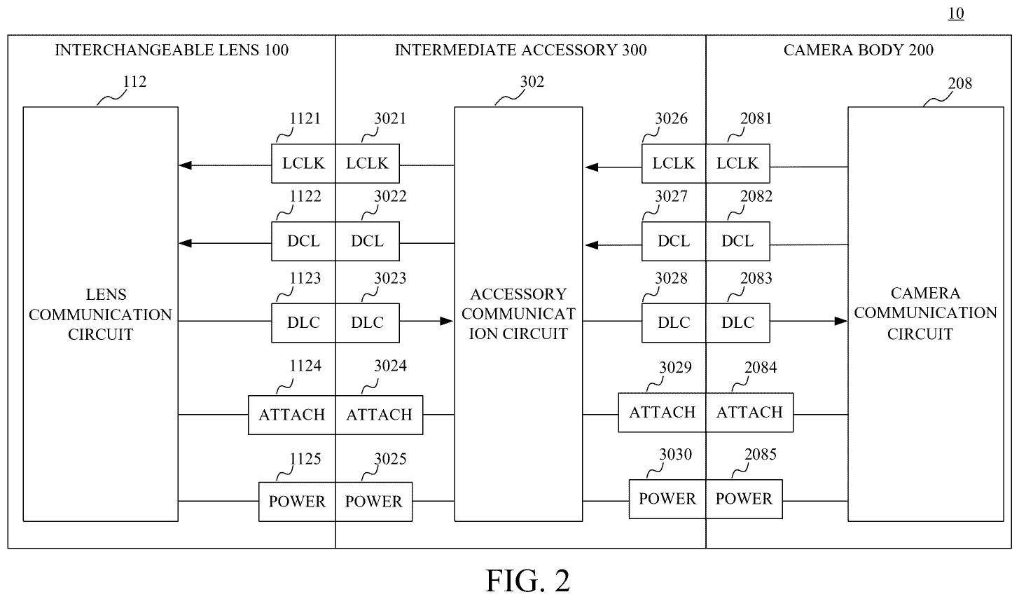

Referring now to FIG. 2, a description will be given of the communication units of the camera body 200, the intermediate accessory 300, and the interchangeable lens 100. FIG. 2 explains the lens communication circuit 112, the accessory communication circuit 302, and the camera communication circuit 208.

The mount 400 provided between the interchangeable lens 100 and the intermediate accessory 300 includes various communication terminals. The interchangeable lens 100 includes communication terminals (LCLK 1121, DCL 1122, DLC 1123, ATTACH 1124, POWER 1125). The intermediate accessory 300 includes communication terminals (LCLK 3021, DCL 3022, DLC 3023, ATTACH 3024, POWER 3025). ATTACH 3024 enables the intermediate accessory 300 to determine the attachment state of the interchangeable lens 100, and power is supplied via POWER 3025. Communication is possible using other communication terminals.

Similarly, various communication terminals are provided on the mount 401 provided between the intermediate accessory 300 and the camera body 200. The intermediate accessory 300 includes communication terminals (LCLK 3026, DCL 3027, DLC 3028, ATTACH 3029, POWER 3030). The camera body 200 includes communication terminals (LCLK 2081, DCL 2082, DLC 2083, ATTACH 2084, POWER 2085). ATTACH 2084 enables the camera body 200 to determine the attachment state of the intermediate accessory 300, and power is supplied via POWER 2085. Communication is possible using other communication terminals. ATTACH 2084 may be configured to be a signal state of in an attached state in a case where the interchangeable lens 100 is attached to the intermediate accessory 300 (ATTACH 3024 indicates the attached state) and the intermediate accessory 300 is attached to the camera body 200.

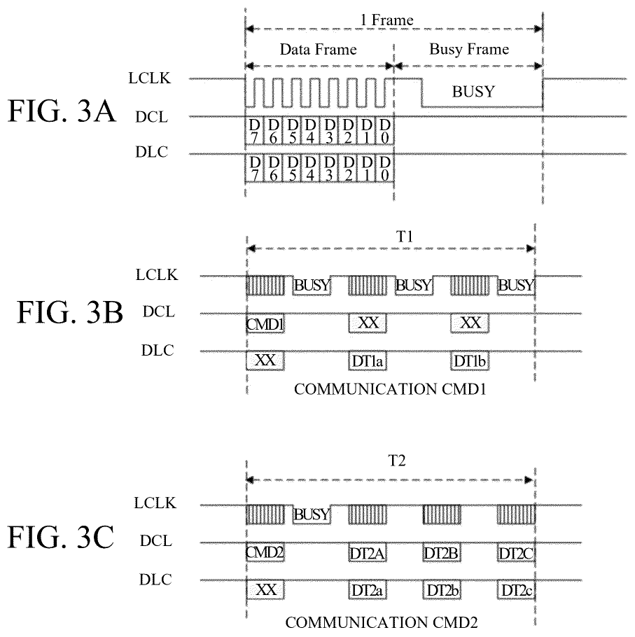

Referring now to FIGS. 3A, 3B, and 3C, a description will be given of an example of a communication method performed using each terminal between the interchangeable lens 100 and the intermediate accessory 300, and between the intermediate accessory 300 and the camera body 200. FIGS. 3A, 3B, and 3C explain an example of a protocol for communication performed among the camera body 200, the intermediate accessory 300, and the interchangeable lens 100.

This communication is performed using a three-wire clock synchronous serial communication method, and is a communication method performed between an apparatus acting as a communication main (master or host) that transmits control commands and data transmission request commands, and an apparatus acting as a communication sub (slave or subsidiary) that transmits data in response to a data transmission request command. In the communication processing performed between the camera body 200 and the intermediate accessory 300, the camera communication circuit 208 serves as the communication main and the accessory communication circuit 302 serves as the communication sub. In the communication processing performed between the intermediate accessory 300 and the interchangeable lens 100, the accessory communication circuit 302 serves as the communication main and the lens communication circuit 112 serves as the communication sub.

The clock signal LCLK is mainly used as a data synchronization clock signal from the communication main to the communication sub. The communication signal DCL is used for data transmission such as control commands and data transmission request commands from the communication main to the communication sub. The data signal DLC is used for data transmission from the communication sub to the communication main. The communication main and the communication sub communicate using a full duplex communication method in which they transmit and receive data to each other and simultaneously in synchronization with a common clock signal LCLK.

FIG. 3A illustrates the waveform of a communication signal for one frame, which is the smallest communication unit. First, the communication main transmits a clock signal LCLK consisting of a set of eight-cycle pulses, and also transmits a communication signal DCL to the communication sub in synchronization with the clock signal LCLK. At the same time, the communication main receives a data signal DLC output from the communication sub in synchronization with the clock signal LCLK. In this way, one byte (8 bits) of data is transmitted and received between the communication main and communication sub in synchronization with a pair of clock signals LCLK. The period during which one byte of data is transmitted and received is called a data frame. After the data frame, a communication pause period is inserted by communication standby request information (simply referred to as a communication standby request hereinafter) BUSY notified from the communication sub to the communication main. The communication pause period is called a BUSY frame. A communication unit consisting of a pair of a data frame and a BUSY frame is called one frame.

FIG. 3B illustrates a waveform of a communication signal consisting of three frames in which the communication main transmits a command CMD1 to the communication sub and receives two bytes of data DT1a and DT1b in response to this command. The type and number of bytes of data DT corresponding to each command CMD are determined in advance between the communication main and the communication sub.

In the first frame, the communication main transmits a clock signal LCLK and also transmits a command CMD1 corresponding to the data DT1a and DT1b requested to be transmitted as a communication signal DCL. The data signal DLC in this frame is treated as invalid data.

Next, the communication main outputs the clock signal LCLK for eight cycles, and then switches the communication terminal state on the communication main side from an output format to an input format. After completing the switching of the communication terminal state on the communication main side, the communication sub switches the communication terminal state on the communication sub side from an input format to an output format. The communication sub then sets a signal level of the clock signal LCLK to a low level (LOW) to notify the communication main of a communication standby request BUSY. The communication main maintains the communication terminal state in the input format while the communication standby request BUSY is being notified, and suspends communication to the communication sub.

The communication sub generates data DT1a corresponding to the command CMD1 while the communication standby request BUSY is being notified. After the communication sub is ready to send the next frame of the data signal DLC, it sets a signal level of the clock signal LCLK to a high level (HIGH) to notify the communication main that the communication standby request BUSY has been cleared. In a case where the communication main recognizes that the communication standby request BUSY has been cleared, it receives the data DT1a from the communication sub by sending one frame of clock signal LCLK to the communication sub. Next, the communication main similarly receives the data DT1b.

In FIG. 3C, the communication main sends the command CMD2 to the communication sub to request it to acquire communication data, and the camera body 200 sends DT2A, DT2B, and DT2C to the interchangeable lens 100. FIG. 3C also illustrates a waveform of a communication signal consisting of four frames, in which the corresponding three-byte lens data DT2a, DT2b, and DT2c are transmitted from the interchangeable lens 100 to the camera body 200. The communication sub notifies the communication main of a communication standby request BUSY in the first frame, but does not notify the communication main of a communication standby request BUSY in the second to fourth frames. Therefore, a period between frames can be reduced. On the other hand, in this communication method, the communication sub cannot notify the communication main of a communication standby request BUSY. Thus, it is necessary to create information to respond to the communication main during the communication standby request BUSY after the command CMD2 received in the first frame, or to prepare information to respond to the communication main before this communication.

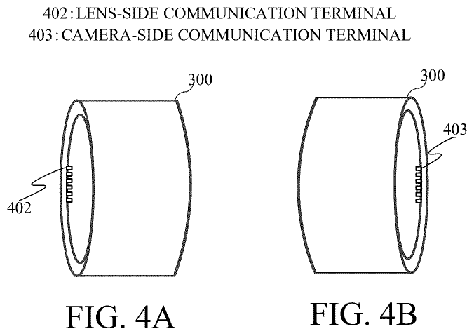

Referring now to FIGS. 4A and 4B, a description will be given of the external appearance of the intermediate accessory 300 according to this embodiment. FIGS. 4A and 4B explain the intermediate accessory 300. FIG. 4A enables the inside of the mount 400 on the interchangeable lens 100 side to be viewed, and the lens-side communication terminal 402 corresponds to LCLK 3021, DCL 3022, DLC 3023, ATTACH 3024, and POWER 3025 in FIG. 2. FIG. 4B enables the inside of the mount 401 on the camera body 200 side to be viewed, and the camera-side communication terminal 403 corresponds to LCLK 3026, DCL 3027, DLC 3028, ATTACH 3029, and POWER 3030 in FIG. 2.

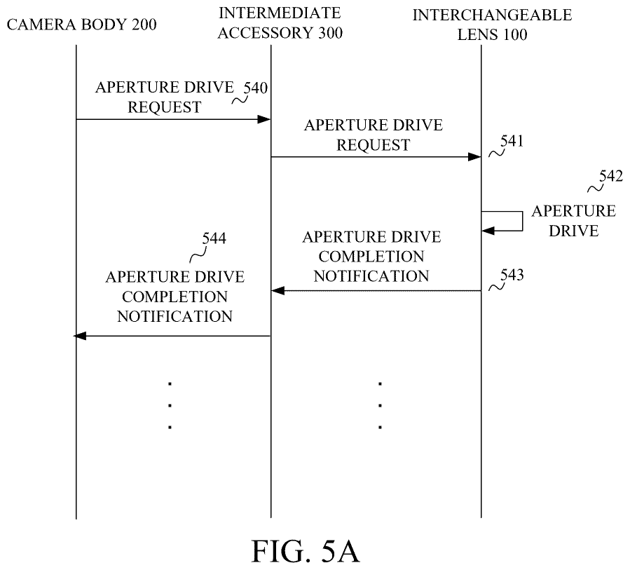

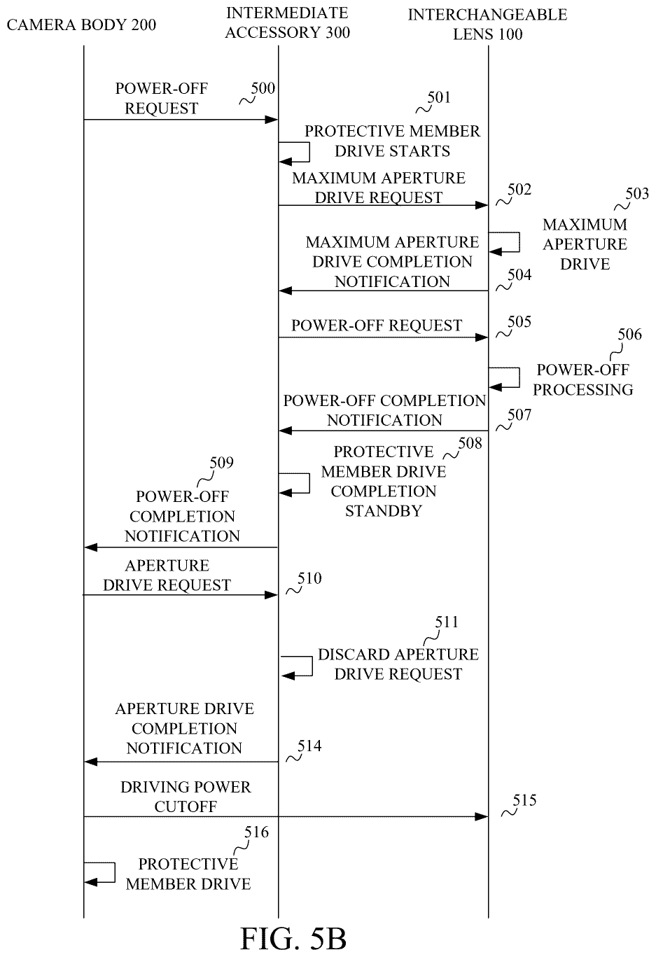

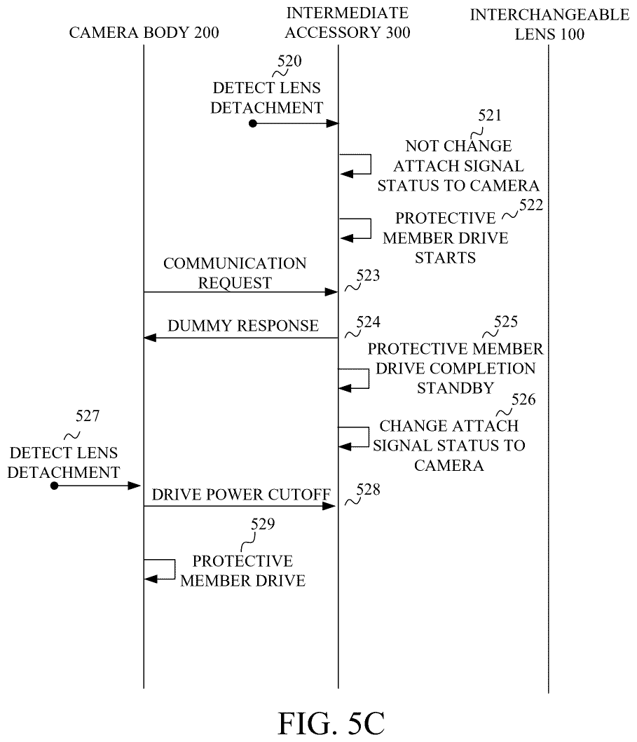

Referring now to FIG. 5A, a description will be given of an aperture drive operation in a live-view image display state on the display unit 206 of the camera body 200 while the camera body 200, interchangeable lens 100, and intermediate accessory 300 are combined. FIG. 5A explains the aperture drive operation in the live-view image display state.

In processing 540, the camera microcomputer 205 in the camera body 200 requests the intermediate accessory 300 to drive the aperture stop so that the aperture unit 114 in the interchangeable lens 100 is in a specified aperture state. For example, in a case where the user operates the dial on the operation unit 207 of the camera body 200, this is a request to set the aperture state corresponding to the set aperture value (F-number).

In processing 541, the accessory microcomputer 301 in the intermediate accessory 300 requests the interchangeable lens 100 to drive the aperture stop. The aperture drive request from the intermediate accessory 300 to the interchangeable lens 100 is equivalent to the aperture drive request from the camera body 200 to the intermediate accessory 300 in processing 540. Here, in a case where the communication methods of the camera body 200 and the interchangeable lens 100 are different and the intermediate accessory 300 is a mount converter, the intermediate accessory 300 edits the communication data to match the communication method of the interchangeable lens 100.

In processing 542, the lens microcomputer 111 in the interchangeable lens 100 drives the aperture unit 114 to achieve the aperture state requested by the camera body 200. Then, in processing 543, the lens microcomputer 111 notifies the intermediate accessory 300 of the completion of the aperture drive.

In processing 544, the accessory microcomputer 301 in the intermediate accessory 300 notifies the camera body 200 of the completion of the aperture drive.

Thus, the aperture drive in the live-view image display state has been described. Details will be described later with reference to FIG. 5B, but for an aperture drive request before a power-off request is received from the camera body 200, communication is executed from the intermediate accessory 300 to the interchangeable lens 100 so that the contents are equivalent.

Referring now to FIG. 5B, a description will now be given of an operation in a power-off state (upon switching from the power-on state to the power-off state) while the camera body 200, the interchangeable lens 100, and the intermediate accessory 300 are combined. FIG. 5B explains the operation in the power-off state.

In processing 500, the camera microcomputer 205 in the camera body 200 requests the intermediate accessory 300 to perform processing regarding power off (to execute processing in changing from a power-on state to a power-off state) (transmits information regarding power off). That is, the accessory microcomputer 301 receives a power-off request (information regarding power off) from the camera body 200.

In processing 501, the accessory microcomputer 301 in the intermediate accessory 300 recognizes that the processing regarding power off has been requested and starts driving the protective member 303. The protective member 303 is driven from an open state to a closed state so as to shield a light beam entering the mount 401 from the interchangeable lens 100 via the intermediate accessory 300. The protective member 303 may include a light shielding curtain, or an aperture stop (diaphragm) similar to the aperture unit 114 in the interchangeable lens 100, but is not limited to them.

In processing 502, the accessory microcomputer 301 in the intermediate accessory 300 requests the interchangeable lens 100 for maximum aperture drive (or to drive the aperture stop to its fully opened position).

In processing 503, the lens microcomputer 111 drives the aperture unit 114 and controls it to be in the maximum aperture state. If an amount by which the aperture in the aperture stop is narrowed down from the fully opened state is less than a predetermined amount, it may be considered to be in the fully opened state even if it is not fully opened. Then, in processing 504, the lens microcomputer 111 notifies the intermediate accessory 300 of the completion of the maximum aperture drive.

In processing 505, the accessory microcomputer 301 in the intermediate accessory 300 requests the interchangeable lens 100 to perform processing regarding power off.

In processing 506, the lens microcomputer 111 executes processing regarding power off. For example, during this processing, the lens microcomputer 111 performs processing such as storing position information of the focus lens 104 in a nonvolatile memory (not illustrated) in the interchangeable lens 100 and locking an image stabilizing unit that has a locking mechanism. Then, in processing 507, the lens microcomputer 111 notifies the intermediate accessory 300 in the completion of processing regarding power off.

In processing 508, the accessory microcomputer 301 waits until the driving of the protective member that was started in processing 501 is completed. After the driving of the protective member is completed, in processing 509, the accessory microcomputer 301 notifies the camera body 200 of the completion of the processing regarding power off. In this embodiment, the driving of the protective member 303 in the intermediate accessory 300 that was started in processing 501 and the maximum drive of the aperture unit 114 in the interchangeable lens 100 are executed in parallel, but this embodiment is not limited to this example. For example, if it is difficult to drive them simultaneously due to circumstances of the power supply from the camera body 200, they may be controlled to be driven exclusively.

In processing 510, the camera microcomputer 205 in the camera body 200 requests the intermediate accessory 300 to drive the aperture stop. The aperture drive request is a request to close the aperture stop in the interchangeable lens 100 for the purpose of protecting the image sensor 201.

In processing 511, the accessory microcomputer 301 recognizes that the request is the aperture drive request after the request for processing regarding power off, and discards the aperture drive request from the camera body 200 without requesting the interchangeable lens 100 for the aperture drive. Thereby, the aperture unit 114 in the interchangeable lens 100 continues to be fully opened. Then, in processing 514, the accessory microcomputer 301 notifies the camera body 200 of the completion of the aperture drive. Although an example has been described in which the protective member 303 is driven in processing 501 upon receiving a request for processing regarding power off in processing 500, the protective member 303 may be driven at another timing after a request for processing regarding power off is received and before the drive power is cut off in processing 515. For example, the protective member 303 may be driven at the timing of receiving the request for aperture drive in processing 510. Similarly, the maximum aperture drive request in the interchangeable lens 100 in processing 502 may be executed at another timing after the request for power off is received and before the drive power is cut off in processing 515. Although the aperture drive request to the interchangeable lens 100 in processing 502 may be executed, the aperture drive request to the interchangeable lens 100 may be omitted, since it is considered that if the aperture is sufficiently close to the fully opened state, damages from sunlight or the like are less likely.

In processing 515, the camera microcomputer 205 cuts off the drive power supplied to the interchangeable lens 100 and the intermediate accessory 300 by the POWER 2085. Then, in processing 516, the camera microcomputer 205 drives the protective member 209 in the camera body 200 to protect the image sensor 201, and then transitions the camera body 200 to a power-off state. The protective member 209 has a focal plane shutter, a light shielding curtain, and the like. In a case where the camera body 200 detects through the communication circuit that the intermediate accessory 300 having the protective member 303 is attached, the protective member 209 may not be driven in processing 516. This is because the protective member 303 in the intermediate accessory 300 shields the incidence light beam on the mount 401, and thereby protects the camera body 200. This configuration can suppress the durability drop of a component due to driving of the protective member 209 in the camera body 200 is driven during the power-off. That is, in a case where the camera microcomputer 205 transmits a power-off request to the intermediate accessory 300 and the intermediate accessory 300 protects the mount portion of the camera body 200 using the protective member 303, the protective member 209 is not driven.

Thus, in this embodiment, in a case where the accessory microcomputer 301 receives information regarding power off (power-off request) from the camera body 200, the accessory microcomputer 301 drives the protective member 303. In this embodiment, in a case where information regarding the driving of the aperture unit 114 of the interchangeable lens 100 is received from the camera body 200, the accessory microcomputer 301 controls the aperture unit 114 via the accessory communication circuit 302. The accessory microcomputer 301 controls the aperture unit 114 differently (in different methods) before and after the accessory microcomputer 301 receives information regarding the power off.

The accessory 300 recognizes a request for processing regarding the power off from the camera body 200 to the interchangeable lens 100, drives the protective member 303, and drives the aperture unit 114 in the interchangeable lens 100 to the fully opened state. The intermediate accessory 300 discards the aperture drive request received after the request for processing regarding power off, and maintains the fully opened state of the aperture stop in the interchangeable lens 100. This configuration can avoid damage to each component in the camera body 200, such as the image sensor and shutter, and each component in the interchangeable lens 100, such as the aperture stop, even if a strong light beam from sunlight or the like is incident on the camera body 200 in the power-off state.

In particular, in a case where an extender configured to change a focal length has a function of the intermediate accessory 300 according to this embodiment, it is very effective in terms of protecting components such as expensive super telephoto lenses that are often used in combination. Although a description is omitted, in a case where the camera body 200 is powered on, the protective member 303 in the intermediate accessory 300, which was closed during the power off, is driven to open. In general, a light shielding curtain can be driven faster than an aperture stop. Therefore, in a case where the protective member 303 is configured as a light-shielding curtain, the camera body 200 can be started more quickly than prior art that protects the image sensor by closing the aperture stop in the interchangeable lens.

Referring now to FIG. 5C, a description will be given of the operation in a case where the interchangeable lens 100 according to this embodiment is detached from the intermediate accessory 300. FIG. 5C explains the operation in a case where the interchangeable lens 100 is detached from the intermediate accessory 300.

In processing 520, the accessory microcomputer 301 in the intermediate accessory 300 detects that the interchangeable lens 100 has been detached by ATTACH 3024 (a signal indicating a change in a state of the interchangeable lens 100).

In processing 521, the accessory microcomputer 301 does not change the state of the ATTACH 3029 signal (leaving the signal indicating whether or not the interchangeable lens 100 is attached, in the attached state). That is, the accessory microcomputer 301 maintains a signal indicating that the interchangeable lens 100 is attached, as a state signal during a period from when it receives ATTACH 3024 from the interchangeable lens 100 to when driving of the protective member 303 is completed. Here, the state signal is a signal sent from the intermediate accessory 300 to the camera body 200 indicating whether or not the interchangeable lens 100 is attached to the intermediate accessory 300. This configuration delays the camera body 200 from detecting that the interchangeable lens 100 has been detached, and maintains the driving power supply from the camera body 200. Then, in processing 522, the accessory microcomputer 301 starts driving the protective member 303.

Thereafter, even if the camera microcomputer 205 in the camera body 200 requests the intermediate accessory 300 to perform arbitrary processing in processing 523, the accessory microcomputer 301 does not perform the processing, and executes a dummy response to the camera body 200 in processing 524.

In processing 525, the accessory microcomputer 301 waits for the drive of the protective member 303 to be completed. Then, in processing 526 after the driving is completed, the accessory microcomputer 301 changes the state of the ATTACH 3029 signal (changes it to a signal indicating that the interchangeable lens 100 is not attached). Thereby, the camera body 200 can detect the detachment of the interchangeable lens 100 (unattached state). In this embodiment, the lens microcomputer 111 changes the state of the ATTACH 3029 signal after confirming that the driving of the protective member 303 is completed, but this embodiment is not limited to this example. In a case where the time required to drive the protective member 303 can be expected to be a fixed time, an electrical circuit may be configured to delay the predetermined time.

In processing 527, the camera microcomputer 205 detects that the interchangeable lens 100 has been detached based on a change in the state of the ATTACH 2084 signal (a change in the state of the interchangeable lens 100). Then, in processing 528, the driving power supplied to the intermediate accessory 300 and the interchangeable lens 100 is cut off by the POWER 2085.

In processing 529, the camera microcomputer 205 drives the protective member 209 in the camera body 200 to protect the image sensor 201 from dust, water droplets, and the like that may adhere to the image sensor 201. Similarly to the driving of the protective member in processing 516 of FIG. 5B, in a case where the camera body 200 detects that the intermediate accessory 300 having the protective member 303 has been attached, the protective member 209 may not be driven. However, in a case where the intermediate accessory 300 is detached after the interchangeable lens 100 has been detached, dust or water droplets may get into the inside of the camera body 200 through the mount 401. Thus, the protective member 209 of the camera body 200 may be driven even in a case where the attachment of the intermediate accessory 300 having the protective member 303 is detected.

Thus, in this embodiment, the accessory microcomputer 301 drives the protective member 303 in a case where it receives a signal regarding a change in the state of the interchangeable lens 100 (a signal indicating that the interchangeable lens 100 has been detached) via the accessory communication circuit 302.

As described above, in this embodiment, the intermediate accessory 300 recognizes that the interchangeable lens 100 has been detached, drives the protective member 303, and then causes the camera body 200 to detect the detachment. That is, in a case where the accessory microcomputer 301 receives a signal regarding a change in the state of the interchangeable lens 100 (a signal indicating whether or not the interchangeable lens 100 is attached to the intermediate accessory 300) via the accessory communication circuit 302, it drives the protective member 303. This configuration can prevent dust, water droplets, and the like that have entered the intermediate accessory 300 from further entering the camera body 200 in a case where the interchangeable lens 100 is detached.

### Second Embodiment

Next, a second embodiment of the present disclosure will be described. The configuration of the camera system according to this embodiment is similar to that of the first embodiment. In the camera system according to this embodiment, the intermediate accessory 300 requests the interchangeable lens 100 for maximum aperture drive in response to an aperture drive request after processing regarding power off is requested by the intermediate accessory 300.

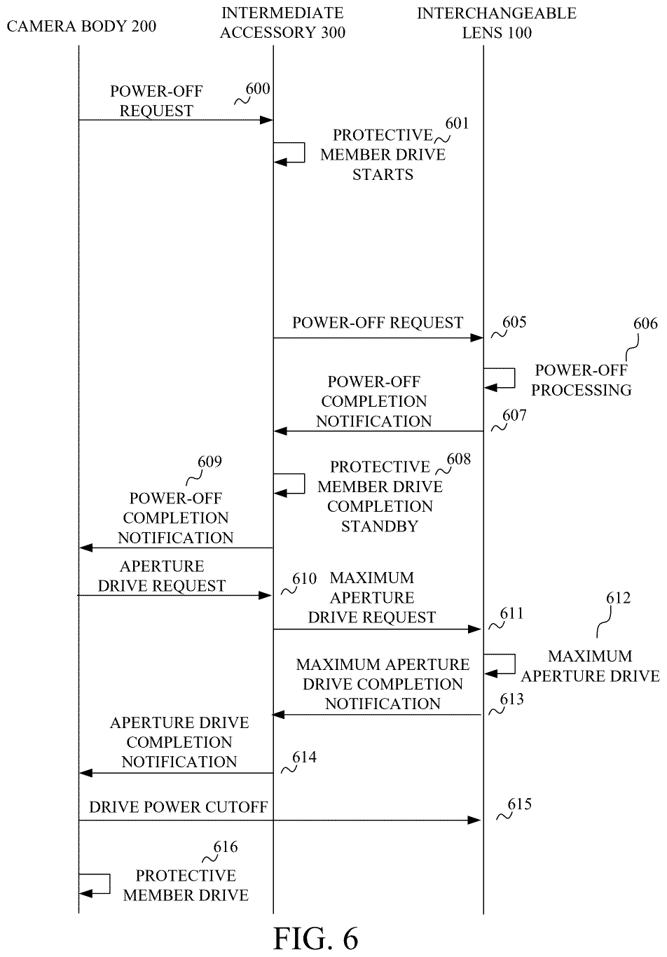

Referring to FIG. 6, a description will be given of an operation during power off while the camera body 200, the interchangeable lens 100, and the intermediate accessory 300 according to this embodiment are combined. FIG. 6 explains the operation during power off according to this embodiment.

Processing 600 to 601 in FIG. 6 are similar to processing 500 to 501 of the first embodiment (FIG. 5B), respectively, and thus a description thereof will be omitted. Thereafter, in the first embodiment, the aperture unit 114 in the interchangeable lens 100 is driven to the maximum aperture position in processing 502 to 504 based on the request from the intermediate accessory 300, but this processing is omitted in this embodiment. It is not essential to omit this processing, but since the aperture unit 114 in the interchangeable lens 100 is driven to the maximum aperture position in processing 611 described later, it becomes redundant. Processing 605 to 609 in FIG. 6 are similar to processing 505 to 509 of the first embodiment (FIG. 5B), respectively, and thus a description thereof will be omitted.

In processing 610, the camera body 200 requests the intermediate accessory 300 to drive the interchangeable lens 100 to close the aperture stop.

In processing 611, the accessory microcomputer 301 recognizes that this is an aperture drive request after a request for processing regarding power off. The accessory microcomputer 301 then edits the content so as to fully open the aperture stop, and requests the interchangeable lens 100 for maximum aperture drive.

In processing 612, the lens microcomputer 111 drives the aperture unit 114 to set the aperture stop to the maximum aperture state. Similarly to the maximum aperture drive in processing 503 of the first embodiment, in a case where an amount of narrowing the aperture from the maximum aperture state is smaller than a predetermined amount, it may be considered to be in the maximum aperture state even if it is not completely in the maximum aperture state. Then, in processing 613, the lens microcomputer 111 notifies the intermediate accessory 300 of the completion of the maximum aperture drive. In processing 614, the accessory microcomputer 301 of the intermediate accessory 300 notifies the camera body 200 of the completion of the maximum aperture drive.

Processing 615 to 616 are similar to processing 515 to 516 of the first embodiment, respectively, and thus a description thereof will be omitted.

As described above, in this embodiment, the intermediate accessory 300 recognizes the request for processing regarding power off from the camera body 200 to the interchangeable lens 100, and drives the protective member 303. In the aperture drive request received after the request for processing regarding power off, the intermediate accessory 300 edits the content and requests the interchangeable lens 100 for the maximum aperture drive, and sets the aperture stop in the interchangeable lens 100 to the fully opened state. Thereby, even if a strong light beam from sunlight or the like is incident on the camera body 200 in the power-off state, this configuration can avoid damage to each component in the camera body 200, such as the image sensor and the shutter, and each component in the interchangeable lens 100, such as the aperture unit 114.

### Third Embodiment

Next, a third embodiment of the present disclosure will be described. The configuration of the camera system according to this embodiment is similar to that of the first embodiment. In the camera system according to this embodiment, the user can select whether to protect the mount of the camera body 200 using the protective member 303 in the intermediate accessory 300 or using the aperture unit 114 in the interchangeable lens 100 as an operation during power off. The user can select it from a menu screen displayed on the display unit 206 of the camera body 200. Alternatively, the selection can be made by switching a switch provided on the accessory operation unit 320 of the intermediate accessory 300, and the switch state can be propagated to the camera body 200. Thus, the display unit 206 or the switch functions as a selection unit (selector) that can select whether to suppress the external element using the protective member 303 or using the aperture unit 114 in the interchangeable lens 100.

In a case where the power supply is cut off while the aperture stop is narrowed down, the interchangeable lens 100 may break down. Some interchangeable lenses have no aperture stops. In this case, even if the user selects to protect the mount portion of the camera body 200 using the aperture unit 114 of the interchangeable lens 100, the mount portion of the camera body 200 may be protected using the protective member 303 in the intermediate accessory 300. That is, the accessory microcomputer 301 determines whether or not it is possible to narrow the aperture unit 114 during power off. In a case where the aperture unit 114 cannot be narrowed, even if the selector selects to protect the mount portion of the camera body 200 using the aperture unit 114, it controls the protective member 303 so that the protective member 303 is used to protect the mount portion.

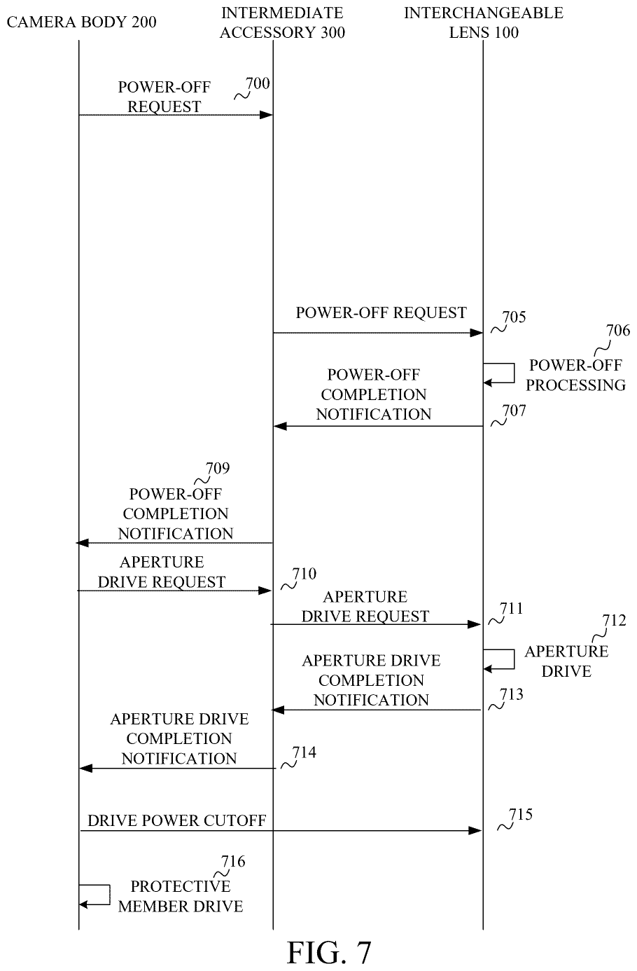

Referring to FIG. 7, a description will be given of an operation during power off while the camera body 200, the interchangeable lens 100, and the intermediate accessory 300 according to this embodiment are combined. FIG. 7 explains the operation during power off according to this embodiment. This embodiment will describe the operation of protecting the mount portion of the camera body 200 using the aperture unit 114 in the interchangeable lens 100. In this embodiment, the operation of protecting the mount portion of the camera body 200 using the protective member 303 in the intermediate accessory 300 is omitted because it is similar to that of the first or second embodiment.

In processing 700, the camera microcomputer 205 in the camera body 200 requests the intermediate accessory 300 to perform processing regarding power off. Information regarding whether the mount 401 is to be protected by the aperture unit 114 in the interchangeable lens 100 or by the protective member 303 in the intermediate accessory 300 is also added to the communication data. The camera microcomputer 205 in the camera body 200 may notify the intermediate accessory 300 in advance by a separate communication. As described in the first embodiment, in a case where the mount 401 is to be protected by the protective member 303 in the intermediate accessory 300, the intermediate accessory 300 subsequently drives the protective member 303 and requests the interchangeable lens 100 for the maximum aperture drive. However, in a case where the mount 401 in the camera body 200 is to be protected by the aperture unit 114 in the interchangeable lens 100, this processing is not performed. Nevertheless, the protective member 303 in the intermediate accessory 300 may be driven.

Processing 705 to 707 and 709 are similar to processing 505 to 507 and 509 of the first embodiment (FIG. 5B), respectively, and thus a description thereof will be omitted.

In processing 710, the camera microcomputer 205 of the camera body 200 requests the intermediate accessory 300 to drive the aperture unit 114 of the interchangeable lens 100 to close it.

In processing 711, the accessory microcomputer 301 recognizes that this is an aperture drive request after the request for processing regarding power off, but does not discard the request unlike the first embodiment, nor edit the contents unlike the second embodiment. Then, in order to protect the mount 401 using the aperture unit 114 in the interchangeable lens 100, the accessory microcomputer 301 requests the interchangeable lens 100 to drive the aperture stop.

In processing 712, the lens microcomputer 111 executes control to drive the aperture unit 114 to close the aperture. Then, in processing 713, the lens microcomputer 111 notifies the intermediate accessory 300 of the completion of the aperture drive.

In processing 714, the accessory microcomputer 301 in the intermediate accessory 300 notifies the camera body 200 of the completion of the aperture drive.

Processing 715 to 716 are similar to processing 515 to 516 in the first embodiment, respectively, and thus a description thereof will be omitted.

As described above, in this embodiment, as the operation during power off, the user can select whether to protect the mount portion of the camera body 200 using the aperture unit 114 in the interchangeable lens 100 or using the protective member 303 in the intermediate accessory 300. This configuration can protect each component in the camera body 200, such as the image sensor and shutter, from incident light such as sunlight by preferentially using either the interchangeable lens 100 or the intermediate accessory 300 based on the user's selection.

Each embodiment can avoid damage to the aperture unit in the interchangeable lens or the image sensor or shutter in the image pickup apparatus, and can suppress adhesion of dust and water droplets to the image sensor. Therefore, each embodiment can provide an accessory that can properly protect the interchangeable lens or the image pickup apparatus, an image pickup apparatus, and control methods for the accessory and the image pickup apparatus.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each embodiment can provide an accessory capable of properly protecting an interchangeable lens or an image pickup apparatus.

This application claims priority to Japanese Patent Application No. 2024-001585, which was filed on Jan. 10, 2024, and which is hereby incorporated by reference herein in its entirety.

What is claimed is:

1. An accessory attachable and detachable between an interchangeable lens and an image pickup apparatus, the accessory comprising:
a communication unit communicable with the interchangeable lens and the image pickup apparatus;
a protective member configured to suppress an external element entering the image pickup apparatus through a mount portion of the image pickup apparatus; and
a processor configured to:
drive the protective member so as to suppress the external element upon receiving information regarding power off from the image pickup apparatus via the communication unit,
control a first aperture unit via the communication unit upon receiving information regarding driving of the first aperture unit in the interchangeable lens from the image pickup apparatus via the communication unit, and
control the first aperture unit using different methods before and after the processor receives the information regarding the power off.

2. The accessory according to claim 1, wherein the protective member includes a light shielding curtain configured to shield incident light as the external element.

3. The accessory according to claim 1, wherein the protective member includes a second aperture unit configured to shield incident light as the external element.

4. The accessory according to claim 1, wherein in a case where the processor detects a reception of the information regarding the power off from the image pickup apparatus, the processor is configured to determine whether or not to drive the protective member so as to suppress the external element, and
wherein in a case where the processor determines that the protective member is to be driven, the processor is configured to:
start driving the protective member, and
communicate with the image pickup apparatus via the communication unit so that power supply from the image pickup apparatus is maintained while the protective member is being driven.

5. The accessory according to claim 1, wherein before the processor receives the information regarding the power off from the image pickup apparatus, the processor is configured to transmit the information regarding driving of the first aperture unit received from the image pickup apparatus to the interchangeable lens via the communication unit, and
wherein after the processor receives the information regarding the power off from the image pickup apparatus, the processor is configured not to transmit the information regarding the driving of the first aperture unit to the interchangeable lens.

6. The accessory according to claim 1, wherein before the processor receives the information regarding the power off from the image pickup apparatus, the processor is configured to transmit the information regarding the driving of the first aperture unit received from the image pickup apparatus to the interchangeable lens via the communication unit, and
wherein after the processor receives the information regarding the power off from the image pickup apparatus, the processor is configured to request the interchangeable lens for maximum aperture drive of the first aperture unit via the communication unit.

7. The accessory according to claim 1, further comprising a selector configured to select whether to suppress the external element using the protective member or the first aperture unit of the interchangeable lens.

8. The accessory according to claim 7, wherein in a case where the processor determines that an aperture in the first aperture unit cannot be narrowed during the power off, the processor is configured to drive the protective member so as to suppress the external element even though the selector has selected to suppress the external element using the first aperture unit.

9. The accessory according to claim 1, wherein the information regarding the power off is a request transmitted from the image pickup apparatus to the accessory, for processing upon changing from a power on state to a power off state.

10. An accessory attachable and detachable between an interchangeable lens and an image pickup apparatus, the accessory comprising:
a communication unit communicable with the interchangeable lens and the image pickup apparatus;
a protective member configured to suppress an external element entering the image pickup apparatus through a mount portion of the image pickup apparatus; and
a processor configured to drive the protective member so as to suppress the external element upon receiving a signal regarding a change in a state of the interchangeable lens via the communication unit.

11. The accessory according to claim 10, wherein the protective member includes a light shielding curtain configured to shield dust as the external element.

12. The accessory according to claim 10, wherein the protective member includes a second aperture unit configured to shield dust as the external element.

13. The accessory according to claim 10, wherein the signal regarding the change in the state of the interchangeable lens is a signal indicating whether or not the interchangeable lens is attached to the accessory.

14. The accessory according to 10, wherein the processor is configured to communicate with the image pickup apparatus via the communication unit so that power supply from the image pickup apparatus is maintained from during a period when the processor receives the signal regarding the change in the state of the interchangeable lens to when driving of the protective member is completed.

15. The accessory according to claim 10, wherein the processor is configured to:
transmit a state signal indicating whether or not the interchangeable lens is attached to the accessory to the image pickup apparatus via the communication unit, and
maintain a signal as the state signal indicating that the interchangeable lens is attached during a period from when the processor receives the signal regarding the change in the state of the interchangeable lens to when driving of the protective member is completed.

16. The accessory according to claim 10, wherein the processor is configured to perform a dummy response to a communication request from the image pickup apparatus during a period from when the processor receives the signal regarding the change in the state of the interchangeable lens to when driving of the protective member is completed.

17. An image pickup apparatus attachable to and detachable from an accessory that is attachable to and detachable from an interchangeable lens, the image pickup apparatus comprising:
an image sensor;
a first protective member configured to protect the image sensor, the accessory including a second protective member configured to suppress external element entering the image pickup apparatus through a mount portion of the image pickup apparatus;
a communication unit communicable with the accessory; and
a processor configured to transmit information regarding power off to the accessory via the communication unit, and not to drive the first protective member in a case where the accessory suppresses the external element using the second protective member or the processor receives a signal indicating that the accessory drives the second protective member, from the accessory via the communication unit.

18. A control method of an accessory that is attachable and detachable between an interchangeable lens and an image pickup apparatus, and includes a communication unit communicable with the interchangeable lens and the image pickup apparatus, and a protective member configured to suppress an external element entering the image pickup apparatus through a mount portion of the image pickup apparatus, the control method comprising:
driving the protective member so as to suppress the external element upon receiving information regarding power off from the image pickup apparatus via the communication unit,
controlling a first aperture unit via the communication unit upon receiving information regarding driving of the first aperture unit in the interchangeable lens from the image pickup apparatus via the communication unit, and
controlling the first aperture unit using different methods before and after the information regarding the power off is received.

19. A control method of an accessory that is attachable and detachable between an interchangeable lens and an image pickup apparatus, and includes a communication unit communicable with the interchangeable lens and the image pickup apparatus, and a protective member configured to suppress an external element entering the image pickup apparatus through a mount portion of the image pickup apparatus, the control method comprising:
driving the protective member to suppress the external element in a case where a signal regarding a change in a state of the interchangeable lens via the communication unit is received.

20. A control method of an image pickup apparatus attachable to and detachable from an accessory that is attachable to and detachable from an interchangeable lens, the image pickup apparatus including an image sensor, a first protective member configured to protect the image sensor, the accessory including a second protective member configured to suppress external element entering the image pickup apparatus through a mount portion of the image pickup apparatus, and a communication unit communicable with the accessory, the control method comprising:
transmitting information regarding power off to the accessory via the communication unit, and
not driving the first protective member in a case where the accessory suppresses the external element using the second protective member or a signal indicating that the accessory drives the second protective member is received from the accessory via the communication unit.
